(19) United States
(12) Patent Application Publication
(10) Pub. No.: US 2019/0019214 A1
(43) Pub. Date: Jan. 17, 2019

(54) EVALUATING PRESENTATION OF CONTENT ITEMS VIA AN ONLINE SYSTEM BASED ON COMMON CHARACTERISTICS OF USERS PRESENTED WITH THE CONTENT ITEMS

(71) Applicant: Facebook, Inc., Menlo Park, CA (US)

(72) Inventors: Ori Hanegby, Saratoga, CA (US); Yossef Eliahu Zomet, Palo Alto, CA (US); Ganesh A. Gopalakrishnan, San Jose, CA (US); Xingyao Ye, Mountain View, CA (US)

(21) Appl. No.: 15/650,642

(22) Filed: Jul. 14, 2017

(51) Int. Cl. G06Q 30/02

(52) U.S. Cl. CPC G06Q 30/0246; G06Q 30/0277

(57) ABSTRACT

An online system presents various content items received from a publishing user to various users. The online system captures information identifying users to whom the content items were presented and identifies actions performed by the users presented with the content items after being presented with the content items. After presenting content items from the publishing user, the online system identifies characteristics of users to whom the content items were presented and determines performance metrics describing presentation of the content items to users having different characteristics or combinations of characteristics. The performance metrics are presented to the publishing user and grouped based on various characteristics of users to whom the content items were presented, allowing the publishing user to evaluate performance of presentation of content items to users having different characteristics.

### BACKGROUND

This disclosure relates generally to presenting content to online system users, and more specifically to identifying content items or users for presentation to an online system user.

Online systems, such as social networking systems, allow users to connect to and to communicate with other users of the online system. Users may create profiles on an online system that are tied to their identities and include information about the users, such as interests and demographic information. The users may be individuals or entities such as corporations or charities. Online systems allow users to easily communicate and to share content with other online system users by providing content to an online system for presentation to other users. An online system may also generate content for presentation to a user, such as content describing actions taken by other users on the online system

A publishing user may provide content items to an online system, which subsequently presents the content items to other users. This allows the publishing user to gain public attention for a user's products or services or to persuade other users to take an action regarding the publishing user's products or services via the online system. Online systems may receive compensation from a publishing user in exchange for presenting content items received from the publishing user or in exchange for users performing actions after being presented with content items received from the publishing user. For example, an online system receives compensation from a publishing user each time a content item provided by the publishing user is displayed to another user on the online system or each time another user is presented with a content item on the online system and interacts with the content item (e.g., selects a link included in the content item), or each time another user performs another action after being presented with the content item.

A publishing user providing content items to an online system often seek to evaluate effectiveness of content items presented to users via an online system. However, conventional online systems provide limited information regarding actions taken by users to whom the online system has presented content items. While conventional online systems may generally identify presentation of content items from a publishing user to various users, information provided by online systems does not allow a publishing user to ascertain information about users to whom content items provided to the online system by the publishing user for presentation.

### SUMMARY

An online system receives content items from a publishing user for presentation to various users of the online system. Each content item includes a creative having content for presentation to users of the online system. Various content items may include targeting criteria, with targeting criteria included in a content item specifying characteristics of users to whom the content item is eligible for presentation. Additionally, content items may also include bid amounts specifying an amount of compensation the publishing user provides to the online system in exchange for presenting the content items for in exchange for users performing one or more specific actions after being presented with content items. The publishing user may include an objective in one or more content items. The objective included in a content item specifies an action the publishing user desires a user to perform after being presented with the content item.

As the online system identifies opportunities to present content to various users, the online system identifies content items eligible for presentation to the various users and selects content items for presentation to various users. Content items received from the publishing user eligible for presentation to a user for whom the online system identifies an opportunity to present content are included in one or more selection processes by the online system, and content items received from the publishing user eligible selected by the one or more selection processes are presented to the user. For example, the online system receives a request for content from a client device associated with a user and provides a content item received from the publishing user selected by one or more selection processes to the client device for presentation to the user. Content items received from the publishing user and included in one or more selection processes for an identified opportunity are content items having at least a threshold amount of targeting criteria satisfied by characteristics of the user or content items that do not include targeting criteria.

Users to whom the online system presented at least one content item received are identified by the online system. In various embodiments, the online system stores an identifier of a content item received from the publishing user in association with a user profile of a user to whom the content item was presented. Alternatively, the online system associates identifiers of users to whom a content item received from the publishing user was presented with an identifier of the content item received from the publishing user. Hence, the online system maintains information allowing the online system to identify content items received from the publishing user presented to other users and to identify users to whom content items received from the publishing user were presented.

After content items received from the publishing user were presented to various users, the online system retrieves characteristics of each user to whom at least one content item received from the publishing user was presented. In various embodiments, the online system retrieves a user profile associated with a user to whom at least one content item received from the publishing user was presented and retrieves characteristics of the user from the retrieved user profile. Any suitable characteristics of an identified user may be retrieved. Example characteristics retrieved by the online system include: demographic information (e.g., age, location, gender, occupation, etc.) of a user, interests of the user, additional content presented to or accessed by the user, and actions performed by the user within a particular time interval. In some embodiments, the online system retrieves characteristics of users to whom at least a threshold number of content items received from the publishing user were presented or to whom one or more content items received from the publishing user were presented within a specific time interval. In some embodiments, the online system retrieves characteristics of the users presented with at least one content item received from the publishing user in response to receiving a request from the publishing user. Alternatively, the online system retreives characteristics of users presented with a content item received from the publishing user after presenting the content item to the user.

From the retrieved characteristics, the online system determines groups of users who were presented with at least one content item received from the publishing user. Each group includes users having one or more common characteristics retrieved by the online system. For example, a group includes users presented with one or more content items received from the publishing user who are associated with a common location or who have ages within a specific range. A user presented with a content item received from the publishing user may be included in different groups, depending on characteristics the user has in common with other users presented with one or more content items received from the publishing user. In some embodiments, each determined group includes two or more users having at least one common characteristic.

For each of the determined groups, the online system generates one or more performance metrics describing presentation of the one or more content items received from the publishing user to users of the determined groups. Hence, a performance metric for a determined group is generated based on actions performed by users of the determined group after being presented with a content item received from the publishing user. For example, the online system generates a performance metric for a group by retrieving actions performed by users of the group after being presented with a content item received from the publishing user and logged by the online system, determining a number of users of the group who performed a specific action after being presented with the content item (e.g., an action matching an objective included in the content item), and determining a ratio of the number of users of the group who performed the specific action to the number of users of the group. Another performance metric generated for the group is a number of a specific action performed by users of the group (e.g., a number of an action identified by an objective included in a content item received from the publishing user presented to users of the group). As another example, the online system generates a performance metric for a group by determining an amount of compensation received from the publishing user in exchange for presenting content items to users of the group, determining a number of a specific action performed by users of the group (e.g., a number of an action identified by an objective included in a content item received from the publishing user presented to users of the group), and determining a ratio of the determined amount of compensation to the determined number of the specific action. Additionally, the online system may determine a performance metric for a group based on a number of times the online system presented a content item received from the publishing user to users of the group. In some embodiments, the online system receives instructions for generating a performance metric from the publishing user and generates the performance metric for each of the determined groups based on the received instructions.

The online system presents information identifying one or more of the determined groups and one or more performance metrics generated for each of the identified groups to the publishing user. In some embodiments, the online system generates a table identifying the one or more characteristics common to users in each group and one or more performance metrics associated with each group and presents the table to the publishing user. The presented information allows the publishing user to evaluate presentation of content items to users having different characteristics, which allows the online system to more accurately evaluate effectiveness of the content items in inducing users to perform various actions.

### BRIEF DESCRIPTION OF THE DRAWINGS

FIG. 1 is a block diagram of a system environment in which a social networking system operates, in accordance with an embodiment.

FIG. 2 is a block diagram of a social networking system, in accordance with an embodiment.

FIG. 3 is a flowchart of a method for evaluating presentation of content items based on characteristics of users to whom the content items were presented, in accordance with an embodiment.

FIG. 4 is an example of information identifying groups of users to whom content items from a publishing user was presented and one or more performance metrics associated with each of the identified groups, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

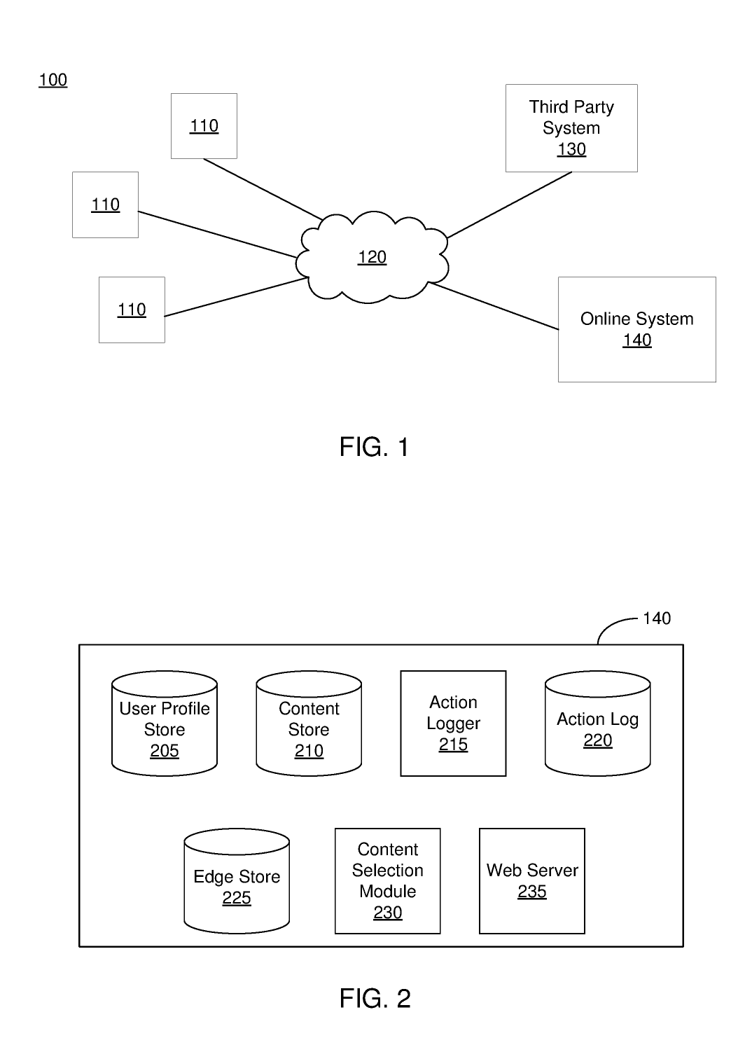

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140. The online system 140 shown in FIG. 2 includes a user profile store 205, a content store 210, an action logger 215, an action log 220, an edge store 225, a content selection module 230, and a web server 235. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include a creative, which is content for presentation to a user, and a bid amount. The creative is text, image, audio, video, or any other suitable data presented to a user. In various embodiments, the creative also specifies a page of content. For example, a content item includes a landing page specifying a network address of a page of content to which a user is directed when the content item is accessed. The bid amount is included in a content item by a user and is used to determine an expected value, such as monetary compensation, provided by an advertiser to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from a user who provided the content item to the online system 140 if content in the content item is displayed. In some embodiments, the expected value to the online system 140 of presenting the content from the content item may be determined by multiplying the bid amount by a probability of the content of the content item being accessed by a user.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

Additionally, a content item may include one or more targeting criteria specified by the user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

One or more content items may be included in a campaign stored in the content store 210. A campaign includes multiple content items and characteristics, with characteristics included in a campaign associated with each content item in a campaign. For example, a bid amount and targeting criteria included in a campaign are associated with each content item in the campaign. As another example, a budget included in a campaign specifies a maximum amount of compensation a publishing user provides to the online system 140 for presenting content items of the campaign to users of the online system 140. Hence, a publishing user may provide a campaign including multiple content items to the online system 140, and specify characteristics affecting presentation of each content item included in the campaign.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140. The connections between users and other objects, or edges, can be uni-directional (e.g., a user following another user) or bi-directional (e.g., a user is a friend with another user).

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. Content items eligible for presentation to the user are retrieved from the content store 210 or from another source by the content selection module 230, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on attributes associated with the user by the online system 140 and based on the user's affinity for different content items. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items eligible for presentation to the user may include content items associated with bid amounts. The content selection module 230 uses the bid amounts associated with content items when selecting content for presentation to the user. In various embodiments, the content selection module 230 determines an expected value associated with various content items based on their bid amounts and selects content items associated with a maximum expected value or associated with at least a threshold expected value for presentation. An expected value associated with a content item represents an expected amount of compensation to the online system 140 for presenting the content item. For example, the expected value associated with a content item is a product of the content item's bid amount and a likelihood of the user interacting with the content item. The content selection module 230 may rank content items based on their associated bid amounts and select content items having at least a threshold position in the ranking for presentation to the user. In some embodiments, the content selection module 230 ranks both content items not associated with bid amounts and content items associated with bid amounts in a unified ranking based on bid amounts and measures of relevance associated with content items. Based on the unified ranking, the content selection module 230 selects content for presentation to the user. Selecting content items associated with bid amounts and content items not associated with bid amounts through a unified ranking is further described in U.S. patent application Ser. No. 13/545,266, filed on Jul. 10, 2012, which is hereby incorporated by reference in its entirety.

For example, the content selection module 230 receives a request to present a feed of content to a user of the online system 140. The feed includes content items such as stories describing actions associated with other online system users connected to the user. The content selection module 230 accesses one or more of the user profile store 205, the content store 210, the action log 220, and the edge store 225 to retrieve information about the user. For example, information describing actions associated with other users connected to the user or other data associated with users connected to the user are retrieved. Content items from the content store 210 are retrieved and analyzed by the content selection module 230 to identify candidate content items eligible for presentation to the user. For example, content items associated with users who not connected to the user or stories associated with users for whom the user has less than a threshold affinity are discarded as candidate content items. Based on various criteria, the content selection module 230 selects one or more of the content items identified as candidate content items for presentation to the identified user. The selected content items are included in a feed of content that is presented to the user. For example, the feed of content includes at least a threshold number of content items describing actions associated with users connected to the user via the online system 140.

In various embodiments, the content selection module 230 presents content to a user through a feed including a plurality of content items selected for presentation to the user. The content selection module 230 may also determine the order in which selected content items are presented via the feed. For example, the content selection module 230 orders content items in the feed based on likelihoods of the user interacting with various content items.

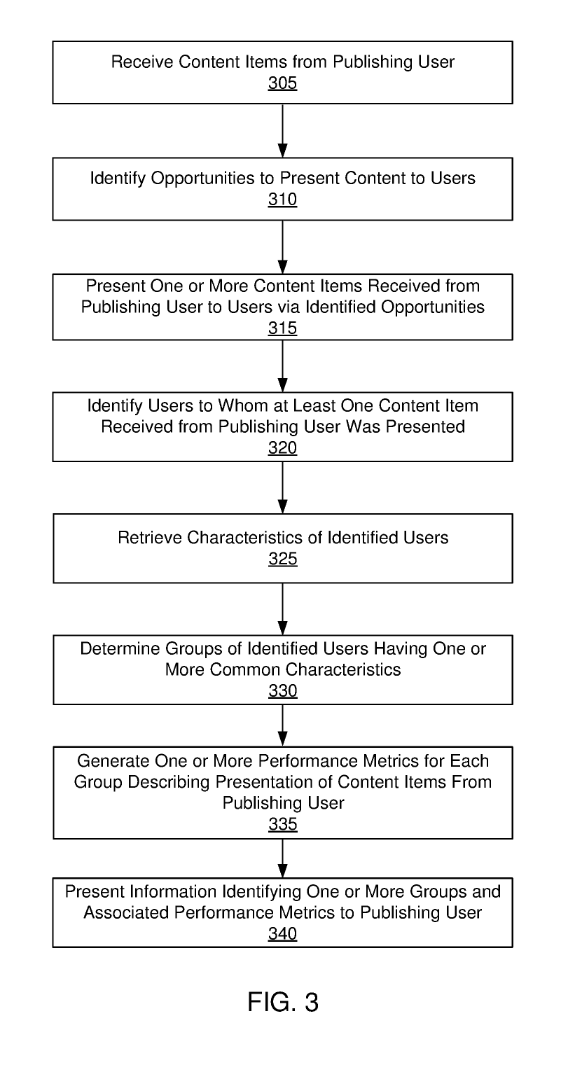

Additionally, the content selection module 230 may provide a publishing user who provided content items to the online system 140 with information describing effectiveness of presentation of the provided content items to other users in causing actions by the other users. To allow the publishing user to more effectively evaluate presentation of content items, the content selection module 230 identifies users to whom one or more content items from the publishing user were presented and determines groups of the identified users based on characteristics of the identified users, as further described below in conjunction with FIG. 3. In various embodiments, identified users having one or more common characteristics are included in each of the determined groups. The content selection module 230 retrieves information from the action log 220 and calculates one or more performance metrics for each of the determined groups. As further described below in conjunction with FIG. 3, a performance metric for a determined group is based on presentation of one or more content items from the publishing user to users of the determined group. For example, a performance metric is based on actions performed by users of the determined group after being presented with a content item from the publishing user. The content selection module 230 provides the performance metrics for various groups along with information identifying various groups to the publishing user.

The web server 235 links the online system 140 via the network 120 to the one or more client devices 110, as well as to the one or more third party systems 130. The web server 235 serves web pages, as well as other content, such as JAVA®, FLASH®, XML and so forth. The web server 235 may receive and route messages between the online system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, or BlackberryOS.

### Evaluating Presentation of Content Items Based on User Characteristics

FIG. 3 is a flow chart of one embodiment of a method for evaluating presentation of content items based on characteristics of users to whom the content items were presented. In various embodiments, the steps described in conjunction with FIG. 3 may be performed in different orders. Additionally, in some embodiments, the method may include different and/or additional steps than those shown in FIG. 3.

The online system 140 receives 305 content items from a publishing user. As further described above in conjunction with FIG. 2, each content item includes a creative having content for presentation to users of the online system 140. Additionally, as further described above in conjunction with FIG. 2, various content items may include targeting criteria, with targeting criteria included in a content item specifying characteristics of users to whom the content item is eligible for presentation. Different content items may also include bid amounts that specify an amount of compensation the publishing user provides to the online system 140 in exchange for presenting the content items for in exchange for users performing one or more specific actions after being presented with content items, as further described above in conjunction with FIG. 2. Additionally, a content item may include an objective that specifies a desired action for a user to perform after being presented with the content item.

In some embodiments, the online system 140 receives 305 a campaign including multiple content items from the publishing user. The publishing user associates targeting criteria with the campaign, so the targeting criteria specify characteristics of users to whom each content item of the campaign is eligible to be presented. Different objectives may be included in different content items of the campaign, or one or more objectives are associated with the campaign as a whole to specify one or more desired actions for users to perform after being presented with a content item of the campaign.

The online system 140 identifies 310 opportunities to present content to various users and presents 315 one or more of the received content items to various users via identified opportunities. For example, the online system 140 receives a request for content from a client device 110 associated with a user and identifies content items eligible for presentation to the user based on characteristics of the user. As further described above in conjunction with FIG. 2, the online system 140 includes content items eligible for presentation to the user in one more selection processes that select content items for presentation to the user. Hence, content items received from the publishing user (e.g., content items received 305 from the publishing user having at least a threshold amount of targeting criteria satisfied by characteristics of the user, content items received 305 from the publishing user that do not include targeting criteria) are included in one or more selection processes by the online system 140. If the one or more selection processes select one or more content items received 305 from the publishing user, the online system 140 presents 315 the selected one or more content items received 305 from the publishing user to the user. For example, the online system 140 communicates the selected one or more content items received 305 from the publishing user to a client device 110 associated with the user for presentation, or the online system 140 generates a feed of content including the selected one or more content items received 305 from the publishing user and communicates the generated feed to the client device 110 associated with the user for presentation. Hence, the online system 140 presents 315 content items received 305 from the publishing user to at least a set of the users for whom opportunities to present content were identified 310.

Users to whom at least one content item received 305 from the publishing user was presented 315 are identified 320 by the online system 140. In various embodiments, the online system 140 stores an identifier of a content item received 305 from the publishing user in association with a user profile of a user to whom the content item was presented 315. Alternatively, the online system 140 associates identifiers of users to whom a content item received 305 from the publishing user was presented with an identifier of the content item received 305 from the publishing user. This allows the online system 140 to maintain a log of content items presented to the user, and to determine to which users a content item was presented 315.

After presenting 315 content items received 305 from the publishing user to various users, the online system 140 retrieves 325 characteristics of each identified user to whom at least one content item received 305 from the publishing user was presented 305. The online system 140 retrieves a user profile associated with a user identified 320 as being presented with at least one content item received 305 from the publishing user was presented 315 and retrieves 325 characteristics of the identified user from the retrieved user profile. Any suitable characteristics of an identified user may be retrieved 325 in various embodiments. For example, the online system 140 retrieves 325 demographic information (e.g., age, location, gender, occupation, etc.) of a user from the user profile of the user, retrieves 325 interests of the user from the user profile of the user, retrieves 325 additional content presented to or accessed by the user from information associated with the user profile, retrieves 325 actions performed by the user within a particular time interval based on information associated with the user profile, or retrieves 325 any combination of the preceding or other suitable information. In some embodiments, the online system 140 retrieves 325 characteristics of users identified 320 as being presented with at least a threshold number of content items received 305 from the publishing user or retrieved 325 characteristics of users identified 320 as being presented with one or more content items received 305 from the publishing user within a specific time interval. The online system 140 may retrieve 325 characteristics of the users identified 320 as being presented with at least one content item received 305 from the publishing user in response to receiving a request from the publishing user. Alternatively, the online system 140 retrieves 325 characteristics of users identified 320 as being presented with at least one content item received 305 from the publishing user after presenting 315 a content item received from the publishing user to the user.

From the retrieved characteristics, the online system 140 determines 330 groups of users identified as being presented with at least one content item from the publishing user. Each group includes users having one or more common characteristics retrieved 325 by the online system. For example, a group includes users presented with one or more content items received 305 from the publishing user who are associated with a common location or who have ages within a specific range. A user presented 315 with a content item received 305 from the publishing user may be included in different groups, depending on characteristics the user has in common with other users presented 315 with one or more content items received from the publishing user. In some embodiments, each determined group includes two or more users having at least one common characteristic.

For each of the determined groups, the online system 140 generates 335 one or more performance metrics describing presentation of the one or more content items received 305 from the publishing user to users of the determined groups. Hence, a performance metric for a determined group is generated 335 based on actions performed by users of the determined group after being presented 315 with a content item received 305 from the publishing user. For example, the online system generates 335 a performance metric for a group by retrieving actions performed by users of the group after being presented 315 with a content item received 305 from the publishing user and logged by the online system 140, determining a number of users of the group who performed a specific action after being presented 315 with the content item (e.g., an action matching an objective included in the content item), and determining a ratio of the number of users of the group who performed the specific action to the number of users of the group. Another performance metric generated 335 for the group is a number of a specific action performed by users of the group (e.g., a number of an action identified by an objective included in a content item received 305 from the publishing user presented 315 to users of the group). As another example, the online system 140 generates 335 a performance metric for a group by determining an amount of compensation received from the publishing user in exchange for presenting 315 content items to users of the group, determining a number of a specific action performed by users of the group (e.g., a number of an action identified by an objective included in a content item received 305 from the publishing user presented 315 to users of the group), and determining a ratio of the determined amount of compensation to the determined number of the specific action. Additionally, the online system 140 may determine a performance metric for a group based on a number of times the online system 140 presented 315 a content item received 305 from the publishing user to users of the group. In some embodiments, the online system 140 receives instructions for generating 335 a performance metric from the publishing user and generates 335 the performance metric for each of the determined groups based on the received instructions.

In some embodiments, the online system 140 generates 335 the one or more performance metrics for each determined group in response to receiving a request from the publishing user. However, in other embodiments, the online system 140 generates 335 the one or more performance metrics for each determined group at periodic intervals. Alternatively, the online system 140 generates 335 the one or more performance metrics for each determined group as content items received 305 from the publishing user are presented 315 to users of each determined group or as users of each determined group perform actions after being presented 315 with content items received 305 from the publishing user.

The online system 140 presents 340 information identifying one or more of the determined groups and one or more performance metrics generated 335 for each of the identified groups to the publishing user. For example, the online system 140 presents 340 the information identifying one or more of the determined groups and their associated performance metrics in response to receiving a request from the publishing user. Alternatively, the online system 140 provides the information identifying one or more of the determined groups and their associated performance metrics to a client device 110 associated with the publishing user at a periodic time interval. In some embodiments, the online system 140 generates a table identifying the one or more characteristics common to users in each group and one or more performance metrics associated with each group and presents 340 the table to the publishing user.

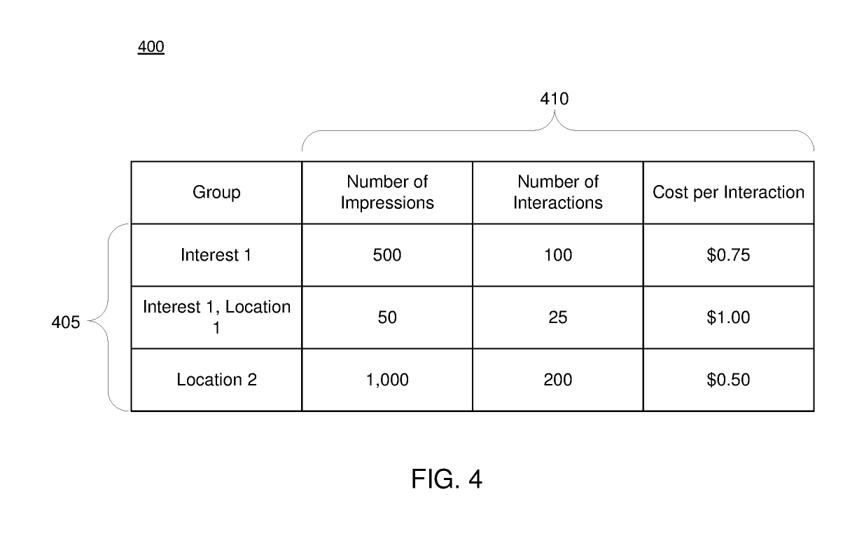

FIG. 4 shows an example of information identifying one or more determined groups and one or more performance metrics associated with each of the identified groups. In the example of FIG. 4, a table 400 with each row 405 corresponding to a determined group and rows 410 corresponding to different performance metrics is shown. Different determined groups are identified using the one or more characteristics common to users of the determined group in FIG. 4. Hence, each row 405 corresponds to a determined group including users having one or more common characteristics. Different columns 410 within a row 405 of the table 400 include different performance metrics calculated for the determined group corresponding to the row 405.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving content items from a publishing user of an online system, each content item including content for presentation by the online system;
identifying opportunities to present content to users of the online system;
presenting one or more of the received content items to at least a set of the users of the online system via the identified opportunities;
identifying users of the set to whom at least one of the received content items were presented;
retrieving characteristics of each identified user of the set maintained by the online system;
determining groups of the identified users of the set, each group including identified users of the set having one or more common characteristics;
generating one or more performance metrics for each of the determined groups, a performance metric for a determined group based on actions performed by users of the determined group after being presented with at least one of the received content items; and
presenting information identifying one or more of the determined groups and performance metrics for the one or more groups to the publishing user, information identifying the determined group specifying the one or more common characteristics of users of the determined group.

2. The method of claim 1, wherein a performance metric for the determined group comprises a number of times a received content item was presented to users of the determined group.

3. The method of claim 1, wherein a performance metric for the determined group comprises a ratio of a number of users of the determined group who performed a specific action after being presented with a received content item to a number of users of the determined group.

4. The method of claim 3, wherein the specific action comprises an action included in the received content item presented to users of the determined group.

5. The method of claim 1, wherein a performance metric for the determined group comprises a number of users of the determined group who performed a specific action after being presented with a received content item.

6. The method of claim 1, wherein a performance metric for the determined group comprises a ratio of an amount of compensation received from the publishing user in exchanging for presenting one or more received content items to a number of times users of the determined group performed a specific action after being presented with a received content item.

7. The method of claim 6, wherein the specific action comprises an action included in the received content item presented to users of the determined group.

8. The method of claim 1, wherein retrieving characteristics of each identified user of the set maintained by the online system comprises:
retrieving characteristics of identified users of the set to whom at least a threshold number of content items received from the publishing user were presented.

9. The method of claim 1, wherein retrieving characteristics of each identified user of the set maintained by the online system comprises:
retrieving characteristics of identified users of the set to whom a content item received from the publishing user was presented within a specific time interval.

10. The method of claim 1, wherein a characteristic of an identified user is selected from a group consisting of: demographic information of the identified user, interests of the identified user, additional content presented to the identified user, actions performed by the identified user, and any combination thereof.

11. A computer program product comprising a non-transitory computer readable medium having instructions encoded thereon that, when executed by a processor, cause the processor to:
receive content items from a publishing user of an online system, each content item including content for presentation by the online system;
identify opportunities to present content to users of the online system;
present one or more of the received content items to at least a set of the users of the online system via the identified opportunities;
identify users of the set to whom at least one of the received content items were presented;
retrieve characteristics of each identified user of the set maintained by the online system;
determine groups of the identified users of the set, each group including identified users of the set having one or more common characteristics;
generate one or more performance metrics for each of the determined groups, a performance metric for a determined group based on actions performed by users of the determined group after being presented with at least one of the received content items; and
present information identifying one or more of the determined groups and performance metrics for the one or more groups to the publishing user, information identifying the determined group specifying the one or more common characteristics of users of the determined group.

12. The computer program product of claim 11, wherein a performance metric for the determined group comprises a number of times a received content item was presented to users of the determined group.

13. The computer program product of claim 11, wherein a performance metric for the determined group comprises a ratio of a number of users of the determined group who performed a specific action after being presented with a received content item to a number of users of the determined group.

14. The computer program product of claim 13, wherein the specific action comprises an action included in the received content item presented to users of the determined group.

15. The computer program product of claim 11, wherein a performance metric for the determined group comprises a number of users of the determined group who performed a specific action after being presented with a received content item.

16. The computer program product of claim 11, wherein a performance metric for the determined group comprises a ratio of an amount of compensation received from the publishing user in exchanging for presenting one or more received content items to a number of times users of the determined group performed a specific action after being presented with a received content item.

17. The computer program product of claim 16, wherein the specific action comprises an action included in the received content item presented to users of the determined group.

18. The computer program product of claim 11, wherein retrieve characteristics of each identified user of the set maintained by the online system comprises:
retrieve characteristics of identified users of the set to whom at least a threshold number of content items received from the publishing user were presented.

19. The computer program product of claim 11, wherein retrieve characteristics of each identified user of the set maintained by the online system comprises:
retrieve characteristics of identified users of the set to whom a content item received from the publishing user was presented within a specific time interval.

20. The computer program product of claim 11, wherein a characteristic of an identified user is selected from a group consisting of: demographic information of the identified user, interests of the identified user, additional content presented to the identified user, actions performed by the identified user, and any combination thereof.
